(19) United States
(12) Patent Application Publication
(10) Pub. No.: US 2007/0157477 A1
(43) Pub. Date: Jul. 12, 2007

(54) Non-Contact Position Sensor with Reversible Self-Adjustment

(76) Inventor: Kai Sellien, Lampertheim (DE)

Correspondence Address: BARLEY SNYDER, LLC, 1000 WESTLAKES DRIVE, SUITE 275, BERWYN, PA, 19312, US

(21) Appl. No.: 11/621,619

(22) Filed: Jan. 10, 2007

(30) Foreign Application Priority Data
Jan. 10, 2006 (DE) 102006001242.9

(51) Int. Cl. G01B 7/30

(52) U.S. Cl. 33/1 PT

(57) ABSTRACT

A non-contact position sensor includes an indicator element mounted on an actuating unit by an assembly apparatus. A detector unit has a sensor for producing a sensor signal in response to a geometrical position of the indicator element relative to the sensor. The actuating unit is moveable in an actuating direction substantially parallel to an actuating axis. The assembly apparatus is rotatable about the actuating axis between a pre-assembled position and a final assembled position. In the pre-assembled position the assembly apparatus holds the indicator element in a defined position relative to the detector unit and in the final assembled position the geometrical position of the indicator element is changeable relative to the detector unit by the actuating unit.

### CROSS-REFERENCE TO RELATED APPLICATIONS

This application claims the benefit of the filing date under 35 U.S.C. §119(a)-(d) of German Patent No. 10 2006 001 242.9, filed Jan. 10, 2006.

### FIELD OF THE INVENTION

The present invention relates to a non-contact position sensor with a detector unit, which has a sensor for producing a sensor signal in response to a geometrical position of a movable indicator element relative to the sensor. In particular, the present invention concerns the kind of position sensor, which is applicable as a proximity switch in place of a mechanical switch.

### BACKGROUND

In automotive engineering, the trend is currently to replace at least some conventional mechanical switches with non-contact proximity switches in motor vehicles. These non-contact proximity switches may include, for example, sensors that work on different physical principles, such as Hall sensors, as well as inductive or capacitive proximity switches. the use of non-contact proximity switches, which re-act faster than mechanical switches, is in principle very advantageous for reliable operation of, for example, brake lights during actuation of a brake pedal in a motor vehicle. The signal causing the switch-on of the brake lights is triggered by the proximity of a passive indicator element to a detector unit and the trigger level is determined by the absolute position of the passive indicator element.

It is frequently provided to make the position of the passive indicator element adjustable relative to the detector unit. Such types of non-contact brake pedal switches are known, for example, from European patent EP 0751 541 B1 and German utility model DE 296 23 230 U1. However, in these examples, the adjustment of the indicator element relative to the detector unit is complex and feedback via the electrical output signal from the detector unit is always needed. Therefore, the assembly operation for mass production of these types of switches is time and cost intensive.

German patent application DE 10 2004 060898 accordingly proposes an arrangement which follows from the idea that self-adjustment can be achieved if the indicator element is installed in a final assembled position on an actuating unit by means of an assembly apparatus wherein its geometrical position can be changed by the actuating unit and in a pre-assembled position is fixed to the detector unit in such a manner that the location of the indicator element corresponds to an exactly defined position relative to the sensor. This self-adjustment is achieved by the fact that the indicator element is only then mounted on the actuating unit when the actuating unit has taken up a likewise exactly defined position, for example, a rest position relative to the detector unit. In this manner, the electrical signal from the sensor need not be used for adjustment of the indicator element thus considerably simplifying the assembly. Using this type of mechanical self-adjustment, a time consuming optimization process can be avoided and good switching accuracy can be assured.

However, the U-shaped assembly apparatus shown in DE 10 2004 060898, which is pushed via the actuating unit for assembly, has the disadvantage that the detector unit is fixed stationarily on an assembly plate, for example, in a footwell of a vehicle, whereas it is often desirable to secure the proximity switch in a pre-mounted position on the pedal block. Furthermore, this arrangement has the disadvantage that if a re-adjustment is required the indicator element can only be returned to the defined starting state of the pre-assembled position with great difficulty.

German Publication DE 198 03 360 A1 discloses a method for the assembly of a position measuring device as well as the apparatus for carrying out this method in which a magnetic orienting element with a stop is provided. The magnetic orienting element cooperates with a stop face of a solid measure and a stop face of a scanning unit and is removed in the oriented position. This solution however has the disadvantage that separate parts are required for the assembly and that it is only usable for angle sensors.

U.S. Pat. No. 6,531,667 B2 discloses a pedal displacement sensor for ascertaining a pedal displacement position. The pedal displacement sensor contains at least an actuating lever and a switching element. In this manner, the actuating lever is mounted in a housing positioned on a rotational axis and can be rotated by a pedal. The actuating element of the switching element is actuated by rotating the actuating lever. A pedal displacement sensor housing has a housing opening which makes exterior access possible to a region located outside the region of the actuating lever in order to subject the actuating lever to the influence of a pedal movement. The actuating lever is preferably constructed as an angle lever which is rotatable at its first arm end and mounted in the housing. An end region of the second lever arm exits with its end face from the housing opening where the pedal lever abuts it. Additionally, the actuating lever acts upon a measuring device which is constructed as an arrangement of a Hall sensor and a permanent magnet. Self-adjustment, however, is not possible with this arrangement.

### BRIEF SUMMARY

It is therefore an object of the present invention is to provide a non-contact position sensor that permits smooth self-adjustment and can be reversibly returned to a pre-assembled position while remaining simple and economical to manufacture. It is further an object of the invention to provide a method for performing the same.

This and other objects are achieved by a non-contact position sensor comprising an indicator element mounted on an actuating unit by an assembly apparatus. A detector unit has a sensor for producing a sensor signal in response to a geometrical position of the indicator element relative to the sensor. The actuating unit is moveable in an actuating direction substantially parallel to an actuating axis. The assembly apparatus is rotatable about the actuating axis between a pre-assembled position and a final assembled position. In the pre-assembled position the assembly apparatus holds the indicator element in a defined position relative to the detector unit and in the final assembled position the geometrical position of the indicator element is changeable relative to the detector unit by the actuating unit.

This and other objects are further achieved by a method for adjusting a non-contact position sensor, comprising: providing an actuating unit that is moveable in an actuating direction substantially parallel to an actuating axis; mounting an indicator element on the actuating unit with an assembly apparatus; providing a detector unit with a sensor that produces a sensor signal in response to a geometrical position of the indicator element relative to the sensor; rotating the assembly apparatus about the actuating axis between a pre-assembled position and a final assembled position; holding the indicator element in a defined position relative to the detector unit in the pre-assembled position with the assembly apparatus; and producing the sensor signal by changing the geometrical position of the indicator element relative to the detector unit with the actuating unit in the final assembled position.

### BRIEF DESCRIPTION OF THE DRAWINGS

FIG. 1 is an exploded perspective view of a non-contact position sensor according to the invention;

FIG. 2 is a perspective view of the non-contact position sensor shown in a pre-assembled position;

FIG. 3 is a partially opened perspective view of the non-contact position sensor shown in FIG. 2;

FIG. 4 is a sectional view taken along line 4-4 in FIG. 3;

FIG. 5 is an enlarged sectional view of the non-contact position sensor shown in FIG. 4;

FIG. 6 is a partially sectional perspective view of the non-contact position sensor shown in a final assembled position;

FIG. 7 is a sectional view taken along line 7-7 in FIG. 6;

FIG. 8 is an enlarged sectional view of the non-contact position sensor shown in FIG. 7;

FIG. 9 is a partially opened perspective view of the non-contact position sensor shown in a position where a brake pedal has been actuated;

FIG. 10 is a partially opened perspective view of the non-contact position sensor shown in FIG. 9 before an unlocking step;

FIG. 11 is a sectional view taken along line 11-11 in FIG. 10; and

FIG. 12 is a partially opened perspective view of the non-contact position sensor shown in a re-unlocked position.

### DETAILED DESCRIPTION OF THE EMBODIMENT(S)

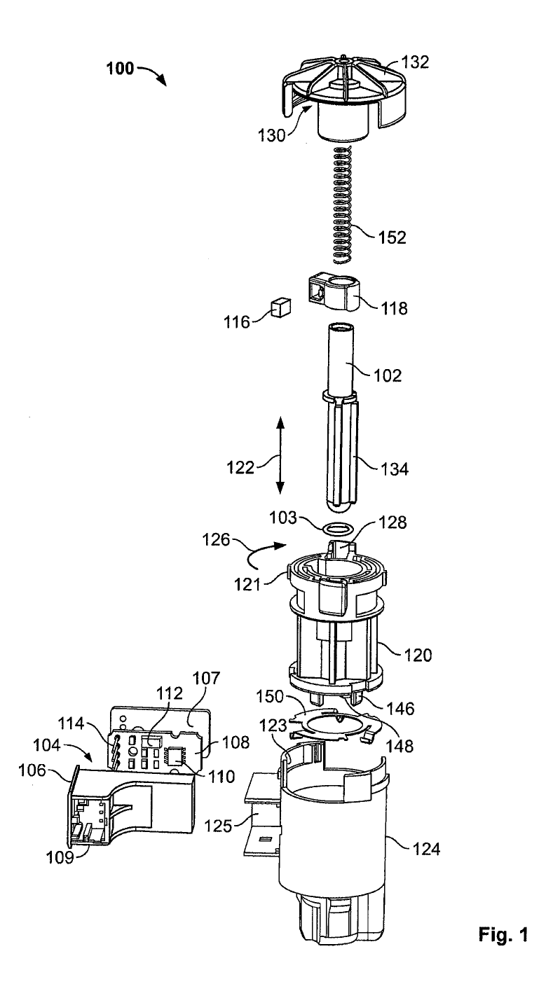

FIG. 1 shows a non-contact position sensor 100 according to the present invention. The non-contact position sensor 100 may be, for example, for a proximity switch or brake light switch for a brake pedal. As shown in FIG. 1, the non-contact position sensor 100 comprises an actuating unit or plunger 102 and a detector unit 104. The actuating unit 102 may be, for example, connected to the brake pedal (not shown) such that the detector unit 104 upon reaching a specific position closes an electrical circuit (not shown) with a brake light (not shown).

In the illustrated embodiment, the detector unit 104 includes a detector housing 106 having a collar 109. The detector housing 106 is fitted with a circuit carrier 108. The circuit carrier 108 includes a sensor 110, signal evaluation components 112, and terminals 114. The terminals 114 are electrically connected to the collar 109. The sensor may be, for example, a Hall sensor or an inductive proximity sensor or eddy current sensor that is influenced by the proximity of a metallic plate (not shown). Systems are also conceivable which work on a capacitive or optical basis. The circuit carrier 108 may be, for example, a printed circuit board (PCB). The detector housing 106 is closed by a cover 107.

The use of a Hall sensor offers the advantage of high measurement accuracy and reliable sensing, which is corrosion-free and substantially free of other undesirable influences, of the position of the indicator element. The Hall sensor reacts very sensitively to changes in the magnetic flux so that even small movements can be ascertained. The characteristics of the Hall sensor can be simply adapted by adaptation of the electrical circuitry for the Hall sensor or programming of the evaluation electronics to desired requirements.

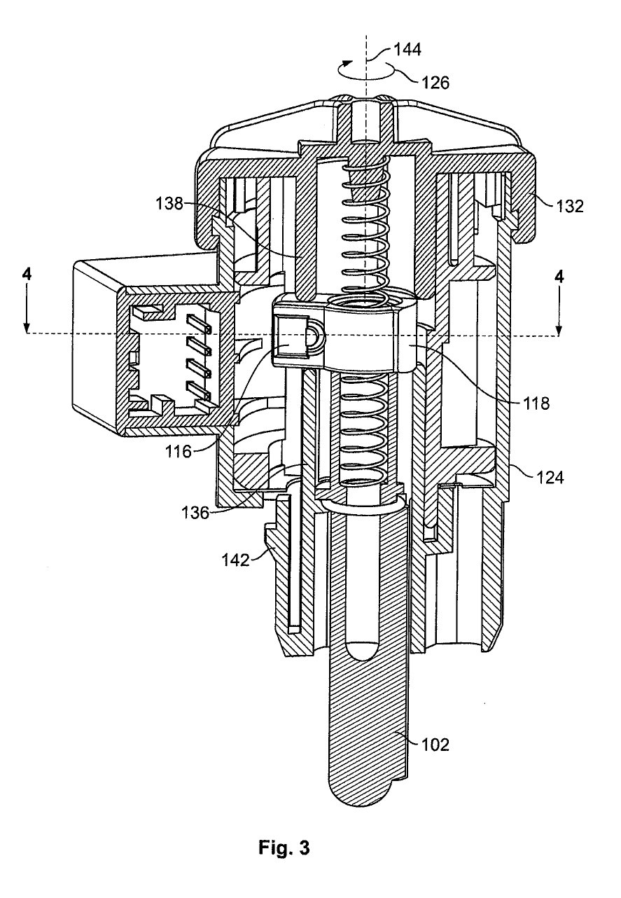

As shown in FIGS. 1 and 3, the actuating unit 102 includes a substantially elongated body having a first end and a second end. Guide protrusions 134 extend along an outer surface of the second end of the actuating unit 102. A return spring 152 is positioned over the first end of the actuating unit 102. A seal 103 preferably of a resilient plastic material is fixed on the actuating unit 102 and serves to muffle noises during actuation of the actuating unit 102. The seal may be, for example, an O-ring. A carrier 118 is fitted on the first end of the actuating unit 102 substantially over the return spring 152. The carrier 118 is provided with an indicator element 116. The indicator element 116 may be, for example, a permanent magnet.

As shown in FIGS. 1-3, the actuating unit 102 and the carrier 118 are received in a mounting element or rotor 120. The carrier 118 and the mounting element 120 are collectively referred to as an assembly apparatus. The mounting element 120 has actuating faces 128 and housing guide protrusions 121 at a first end thereof. At an opposite end, the mounting element 102 is provided with securing members 146 and a cam 148. The securing members 146 may be, for example, catch hooks.

The mounting element 120 is received in a housing 124. A compensation spring 150 is arranged in the housing 124. Radial guide grooves 123 corresponding to the housing guide protrusions 121 on the mounting element 120 are provided on the housing 124. As shown in FIG. 3, engagement members 142, such as catch-hooks, are equally distributed about a circumference of the housing 124. The engagement members 142 are configured to attach the brake pedal (not shown) to the housing 124. A first stop 136 is formed inside the housing 124 and extends from an internal bottom surface thereof. As shown in FIG. 1, a detector unit receiving socket 125 extends from the housing 124.

As shown in FIG. 1, a lid 132 is provided to close the housing 124. The lid 132 has a plurality of actuating face receiving openings 130. A second stop 138 extends downward from an interior surface of the lid 132, as shown in FIG. 3.

A method of assembling the non-contact position sensor 100 will now be described. The circuit carrier 108 fitted with the sensor 110 in inserted into the detector housing 106 and is closed with the cover 107. The detector unit 104 is then fitted in the detector unit receiving socket 125 on the housing 124. The compensation spring 150 is inserted into the housing 124. The mounting element 120 is mounted on the compensation spring 150.

The seal 103 is fixed on the actuating unit 102. The actuating unit 102 is positioned in the housing 124 so that the protrusions 134 fit into the corresponding guide grooves on the housing 124. The indicator element 116 is warm-caulked in the carrier 118. The carrier 118 is then fitted in the corresponding socket on the mounting element 120. In this position, the carrier 118 rests on the first stop 136 of the housing 124.

The return spring 152 is fitted over a corresponding positioning mandrel on the lid 132. The lid 132 is positioned on the housing 124 and engages therewith. The actuating faces 128 are accessible through the actuating face receiving openings 130 on the lid 132. The actuating unit 102 comes into contact with the brake pedal (not shown).

The non-contact position sensor 100 is thus in a pre-assembled position. In the pre-assembled position, the non-contact position sensor 100 can be locked on a pedal socket (not shown) of the brake pedal (not shown) with the aid of the engagement members 142. In this state, the whole pedal block can be stored and be supplied and need not be supplied as a separate part or arranged in a footwell panel and the actual adjustment is only carried out on a vehicle.

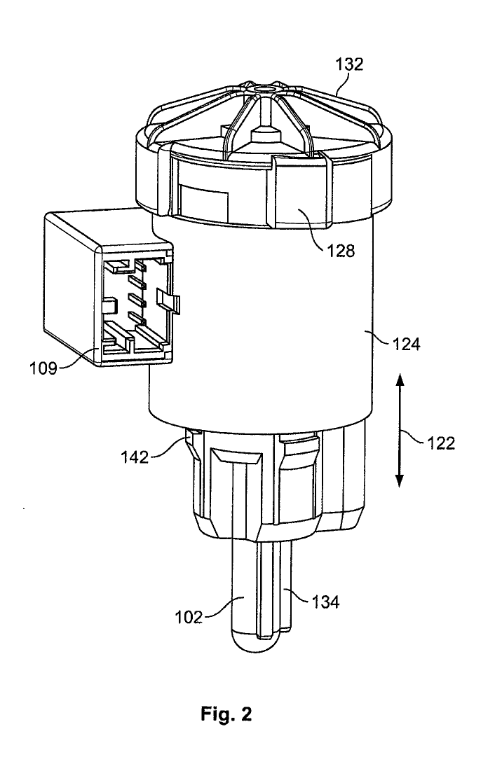

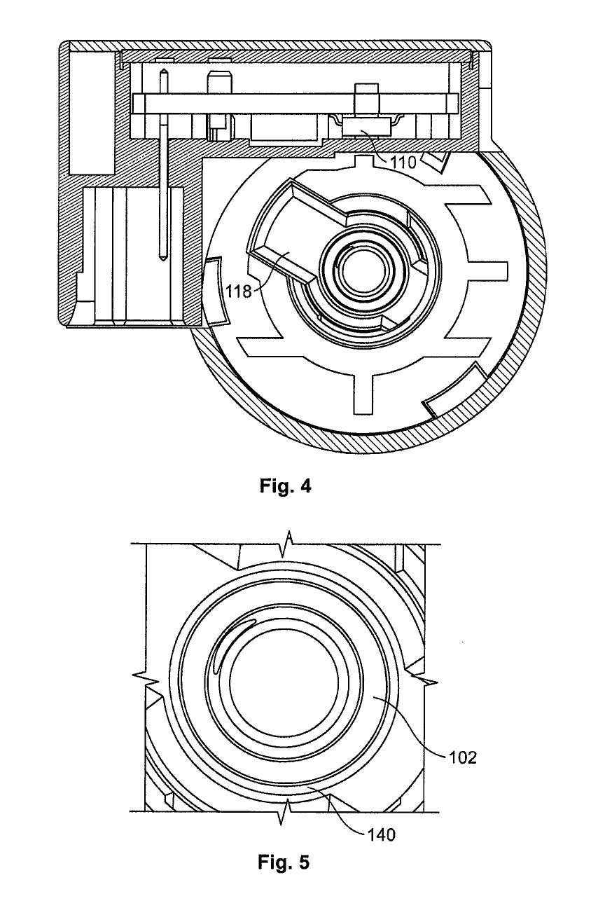

In the pre-assembled position shown in FIGS. 2-5, the actuating unit 102 is located in a position that corresponds to a zero position of the brake pedal (not shown) connected to the actuating unit 102. The guide protrusions 134 of the actuating unit 102 cooperate with associated grooves in the housing 124 so that the actuating unit 102 may be moved in an actuating direction 122 relative to the housing 124 but cannot be rotated.

As shown in FIG. 3, the indicator element 116, which is held in the carrier 118 is positioned between the first stop 136 on the housing 124 and the second stop 138 on the lid 132. The carrier 188 is positioned in an axial direction relative to the detector unit 104 and the sensor 110. In this position, the actuating unit 102 is freely movable in the actuating direction 122 relative to the carrier 118. The actuating unit 102 is freely movable in the actuating direction 122 relative to the carrier 118, because the external diameter of the actuating unit 102 and the internal diameter of the magnet carrier 118 are substantially elliptically constructed so that in the pre-assembled position a longitudinal axis of these ellipses are congruent or substantially parallel to each other. A spaced region 140 (FIG. 5) is thereby provided by which sufficient play is available so that the actuating unit 102 is freely movable in the actuating direction 122 relative to the carrier 118.

Where the external diameter of the actuating unit 102 and the internal diameter of the magnet carrier 118 are substantially elliptically, in each case a long and a short axis, the axes are so selected, that in the case of a concentric arrangement in which at any one time the short axis and the long axis do not form an angle with each other, sufficient play is available for the actuating unit 102 to move in the actuating direction 122 through the non-contact position sensor 100. On the other hand, in the case of a rotation of both elliptical diameters counter to each other for the longer axis of the actuating unit to be at least as long as the short axis of the internal diameter of the assembly. Other elongate forms can also be used in arbitrary combinations, as long as sufficient play only occurs in the pre-assembled position. In a final assembled position described below, wherein the mounting element 120 is rotated opposite to the pre-assembled position, the elliptical diameters are configured such that force-fitting of the mounting element 120 on the actuating unit 102 is assured.

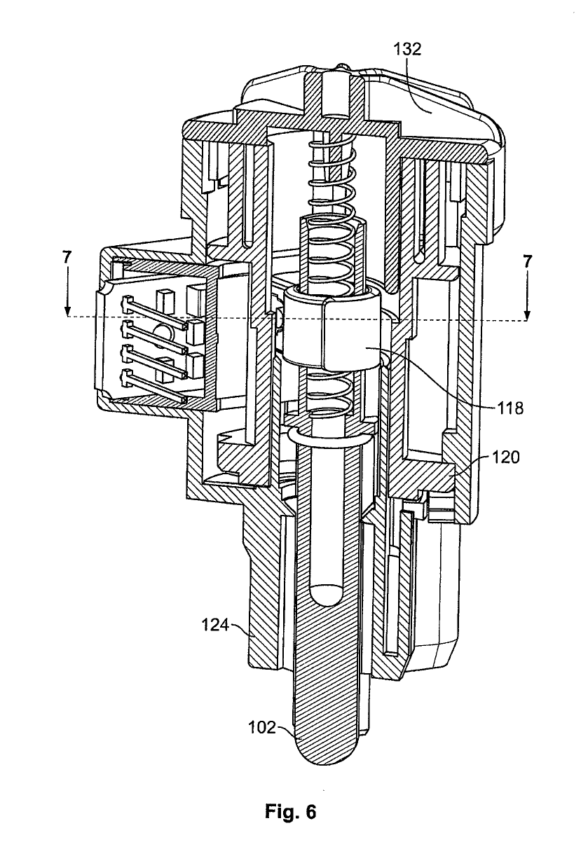

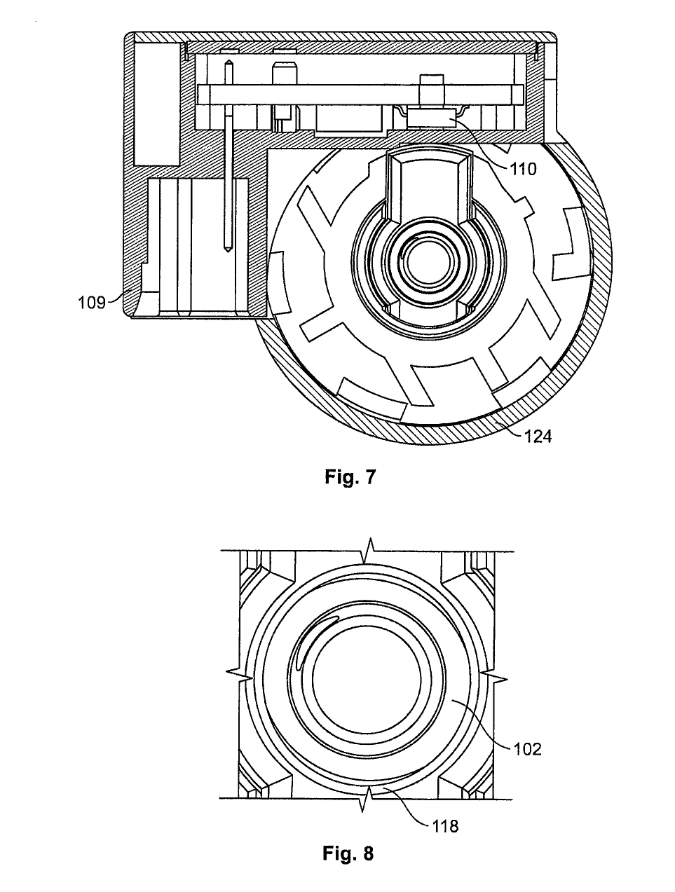

Movement of the non-contact position sensor 100 to a final assembled position will now be described with reference to FIGS. 6-8. Movement from the pre-assembled position shown in FIG. 3 into the final assembled position shown in FIG. 6 is effected by rotation of the mounting element 120 in a direction 126 about an actuating axis 144 (FIG. 3) defined by the actuating unit 102. The rotational movement of the mounting element in the direction 126 may be carried out by an operator (not shown) with the aid of the actuating faces 128. During this rotational movement, the mounting element 120 is guided by the housing guide protrusions 121 in the radial guide grooves 123 provided on the housing 124 and is held in an axial direction.

The carrier 118 is held during this rotation such that its position in a longitudinal direction relative to the actuating unit 102 and relative to the sensor 110 does not change. Because the actuating unit 102 is gripped with the aid of the guide protrusions 134 on the housing 124, the elliptical external diameter of the carrier 118 rotates due to the rotational movement of the mounting element 120 in such a manner that the longitudinal axes of both of the elliptical diameters enclose an angle.

As shown in FIG. 8, if suitable geometrical dimensions are selected then a force fit of the actuating unit elliptical external diameter occurs within the also elliptical carrier internal diameter. Thus, the indicator element 116 retained within the carrier 118 is firmly fixed on the actuating unit 102 and simultaneously is also automatically adjusted relative to the sensor 110 in the optimum manner. During rotation, the indicator element 116 is moved out from the first and second stops 136, 138 along a radially peripheral face and is located in a guide groove in which the indicator element 116 is movable in the actuating direction 122 by the actuating unit 102 in response to movement of the brake pedal (not shown). The position of the actuating unit 102 shown in FIG. 6 corresponds to a position in which the brake pedal (not shown) is not actuated and is therefore still at the zero position. The geometrical position of the actuating unit 102 is thereby detected by the sensor 110, which measures the magnetic field of the indicator element 116 fitted to the actuating unit 102.

In the final assembled position, the securing members 146 grip behind the engagement members 142 to prevent unintentional release of the non-contact position sensor 100 from the brake pedal (not shown). Additionally, the compensation spring 150 is tensioned by the cam 148 to ensure that no more play occurs between the pedal socket (not shown) and the non-contact position sensor 100.

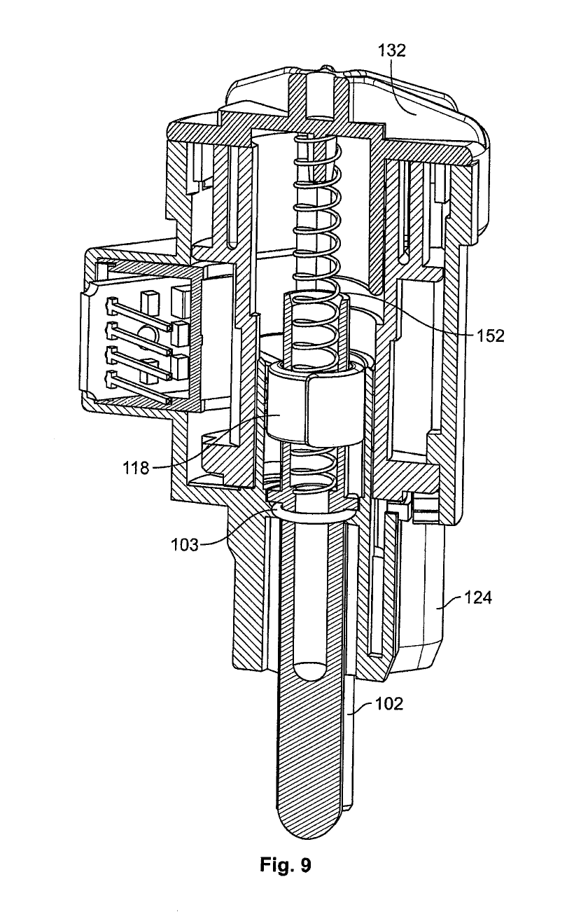

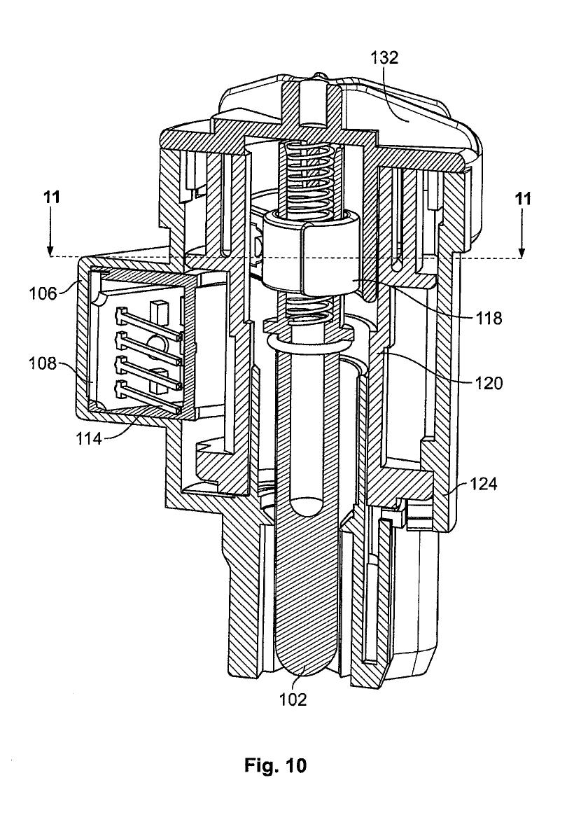

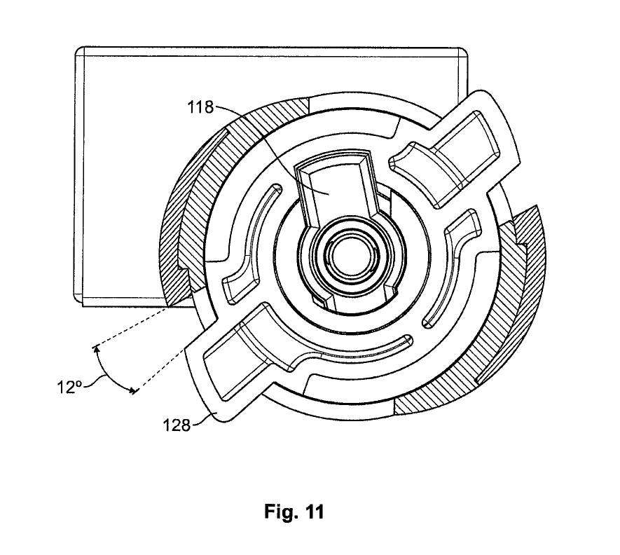

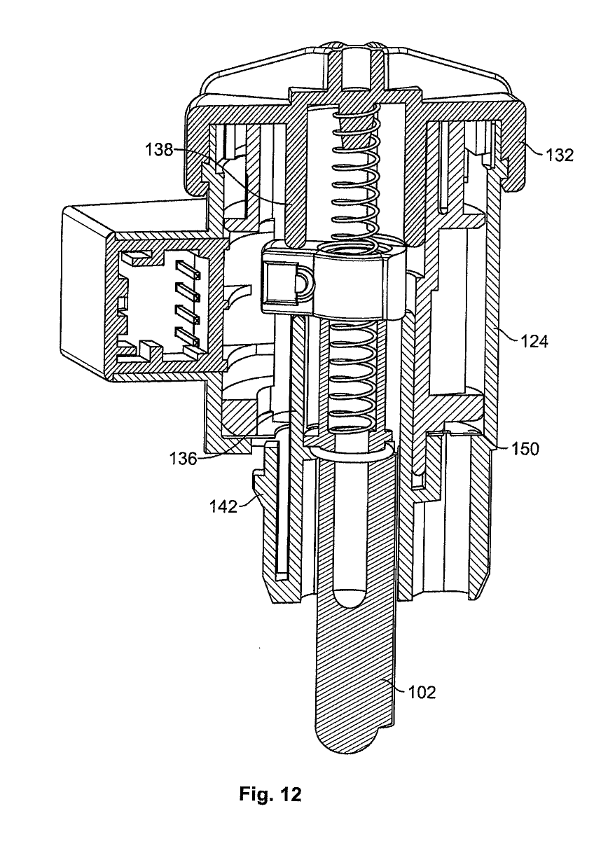

The non-contact position sensor can be returned to the pre-assembled position particularly simply due to the force-fit attachment of the carrier 118 to the actuating unit 102, as shown in FIGS. 9-12. As shown in FIG. 9, during normal operation, when the brake pedal (not shown) is actuated, the actuating unit 102 is moved downwards due to the effect of the return spring 152, and the carrier 118 is guided with the indicator element 116 in a corresponding guide groove on the housing 124. If, however, an adjustment is necessary, this can be effected if the brake pedal (not shown) is completely drawn back so that the actuating unit 102 is pressed up to the lid 132, as shown in FIG. 10. Together with the actuating unit 102, the carrier 118 is also moved into a corresponding guide groove in the lid 132. Because the guide groove is wider than the corresponding guide groove in the housing 124, the mounting element 120 can be turned back by approximately 12 degrees, as shown in FIG. 11. A side wall of the guide groove in the lid 132 forms a stop for this rotational movement.

If the brake pedal (not shown) is now unloaded, the actuating unit 102 moves back out of the lid 132 under the spring force of the return spring 152. The carrier 118, upon entering into the housing 124, meets the first stop 136. If in this position the mounting element 120 is rotated back into the pre-assembled position, the force-fit between the carrier 118 and the actuating unit 102 is released and simultaneously the carrier 118 is held again in the pre-assembled position between the first stop 136 and the second stop 138. Additionally, the securing members 146 are freed from the engagement members 142. Thus, in the event of damage, the non-contact position sensor 100 can be removed without difficulty and exchanged or repaired.

Following the principles according to the invention, a non-contact position sensor 100 can be created which allows a simple smooth adjustment of a brake light switch in order to compensate for brake pedal tolerances and at the same time can be supplied pre-assembled on the brake pedal (not shown). Furthermore, the non-contact position sensor 100 may be set back to the pre-assembled position as often as desired and is easily adjustable. Adjustment is therefore performed mechanically such that an electrical signal from the sensor 110 need not be used for adjustment of the indicator element 116, which considerably simplifies assembly and guarantees good switching accuracy.

The foregoing illustrates some of the possibilities for practicing the invention. Many other embodiments are possible within the scope and spirit of the invention. For example, the force-fit between the actuating unit 102 and the carrier 118 can alternatively be produced using arbitrary longitudinally formed and correspondingly matched cross-sectional forms. Furthermore, more than one sensor 110 and more than one indicator element 116 can be provided in the non-contact position sensor 100 according to the invention. It is, therefore, intended that the foregoing description be regarded as illustrative rather than limiting, and that the scope of the invention is given by the appended claims together with their full range of equivalents.

What is claimed is:

1. A non-contact position sensor, comprising:
an indicator element mounted on an actuating unit by an assembly apparatus;
a detector unit having a sensor for producing a sensor signal in response to a geometrical position of the indicator element relative to the sensor;
the actuating unit being moveable in an actuating direction substantially parallel to an actuating axis; and
the assembly apparatus being rotatable about the actuating axis between a pre-assembled position and a final assembled position, in the pre-assembled position the assembly apparatus holds the indicator element in a defined position relative to the detector unit and in the final assembled position the geometrical position of the indicator element is changeable relative to the detector unit by the actuating unit.

2. The non-contact position sensor of claim 1, wherein the assembly apparatus is tubular.

3. The non-contact position sensor of claim 1, wherein the actuating unit is movable relative to the assembly apparatus in the pre-assembled position and the assembly apparatus is fixed on the actuating unit in the final assembled position.

4. The non-contact position sensor of claim 3, wherein the actuating unit has a substantially elliptical external diameter and the assembly apparatus has a substantially elliptical internal diameter.

5. The non-contact position sensor of claim 1, wherein the assembly apparatus consists of a carrier in which the indicator element is contained and a mounting element in which the carrier is axially movably guided and fixed in a radial direction.

6. The non-contact position sensor of claim 1, further comprising a housing that at least partially surrounds the assembly apparatus, the detector unit being mounted on the housing.

7. The non-contact position sensor of claim 6, wherein at least one engagement member is provided on the housing for attaching a brake pedal to the housing.

8. The non-contact position sensor of claim 7, wherein at least one securing member is provided on the assembly apparatus, the securing member engaging the engagement member in the final assembled state.

9. The non-contact position sensor of claim 1, wherein the assembly apparatus has an actuating face accessible from an exterior of the assembly apparatus.

10. The non-contact position sensor of claim 1, further comprising a return spring that moves the actuating unit in the actuating direction.

11. The non-contact position sensor of claim 1, wherein the indicator element is a permanent magnet.

12. A method for adjusting a non-contact position sensor, comprising:
providing an actuating unit that is moveable in an actuating direction substantially parallel to an actuating axis;
mounting an indicator element on the actuating unit with an assembly apparatus;
providing a detector unit with a sensor that produces a sensor signal in response to a geometrical position of the indicator element relative to the sensor;
rotating the assembly apparatus about the actuating axis between a pre-assembled position and a final assembled position;
holding the indicator element in a defined position relative to the detector unit in the pre-assembled position with the assembly apparatus; and
producing the sensor signal by changing the geometrical position of the indicator element relative to the detector unit with the actuating unit in the final assembled position.

13. The method of claim 12, wherein the assembly apparatus is tubular.

14. The method of claim 12, wherein the actuating unit is movable relative to the assembly apparatus in the pre-assembled position and the assembly apparatus is fixed on the actuating unit in the final assembled position.

15. The method of claim 14, wherein the actuating unit has a substantially elliptical external diameter and the assembly apparatus has a substantially elliptical internal diameter.

16. The method of claim 12, wherein the assembly apparatus consists of a carrier in which the indicator element is contained and a mounting element in which the carrier is axially movably guided and fixed in a radial direction.

17. The method of claim 12, further comprising providing a housing that at least partially surrounds the assembly apparatus, the detector unit being mounted on the housing.

18. The method of claim 17, wherein at least one engagement member is provided on the housing for attaching a brake pedal to the housing and at least one securing member is provided on the assembly apparatus that engages the engagement member in the final assembled state.

19. The method of claim 12, further comprising providing a return spring that moves the actuating unit in the actuating direction.

20. The method of claim 12, wherein the indicator element is a permanent magnet.
